(19) United States
(12) Patent Application Publication
(10) Pub. No.: US 2021/0284338 A1
(43) Pub. Date: Sep. 16, 2021

(54) ASYMMETRIC AIRCRAFT CONFIGURATION

(71) Applicant: Airbus Operations S.L., Getafe (ES)

(72) Inventors: Diego GARCIA MARTIN, GETAFE (ES); Raul Carlos LLAMAS SANDIN, GETAFE (ES)

(21) Appl. No.: 17/197,813

(22) Filed: Mar. 10, 2021

(30) Foreign Application Priority Data
Mar. 12, 2020 (EP) 20382182.2

(51) Int. Cl. B64C 39/00; B64C 39/08; B64C 25/04; B64C 3/56; B64C 25/10; B64C 7/00; B64D 27/02

(52) U.S. Cl. CPC B64C 39/029; B64C 39/08; B64C 25/04; B64D 27/02; B64C 25/10; B64C 7/00; B64C 3/56

(57) ABSTRACT

An asymmetric aircraft configuration having a first and a second wing, the first wing having a span larger than the second wing. A first engine is mounted on the first wing, and a second engine mounted on the rear end of the aircraft with its centerline aligned with the aircraft longitudinal axis. The rear end of the aircraft has a T tail, and the second engine is configured to ingest and consume air forming a boundary layer during the flight. A main landing gear assembly includes a first landing gear attached to the first wing, and a second landing gear attached to an area of the fuselage close to the second wing.

### CROSS-REFERENCES TO RELATED APPLICATIONS

This application claims the benefit of the European patent application No. 20382182.2 filed on Mar. 12, 2020, the entire disclosures of which are incorporated herein by way of reference.

### FIELD OF THE INVENTION

The present invention refers to an asymmetric aircraft having a propulsion system that comprises one conventional engine mounted on a wing, and a second engine designed as a boundary layer ingestion (BLI) engine installed at the rear end of the aircraft.

### BACKGROUND OF THE INVENTION

Several studies have been carried out with the aim of increasing the propulsion efficiency of an aircraft. A propulsion efficiency increment reduces the environmental impact and the operating cost of an aircraft. One of the aspects that have been identified to improve the propulsion efficiency consists of using a boundary layer ingestion (BLI) engine. A BLI engine refers to an engine mounted at the rear of a fuselage, in such a way that is able to ingest the air coming from the boundary layer of the fuselage.

Several aircraft have been developed in order to ingest the boundary layer. FIG. 1 shows an essentially symmetric aircraft with two conventional engines (15) mounted under the wings, and a third auxiliary thruster consisting of a boundary layer ingestion engine (16). This design increases the propulsion efficiency of the aircraft, but it also increases its operational cost with respect to a two-engine aircraft.

FIG. 2 shows another essentially symmetric design with two engines (17) installed at the rear end of the fuselage. The operational cost of the aircraft is mainly maintained by the use of two engines, but the installation of the two engines together may entail a risk of losing both engines at a time in an event of an uncontained explosion.

FIG. 3 shows an asymmetric aircraft design with a propeller propulsion. The aircraft comprises two kind of fuselages (20, 21), one hosting the pilot and the passengers being carried by a main engine (18), and the other one hosting a potential cargo and being carried by a secondary engine (19). The main engine (18) produces more power than the secondary engine (19). The aircraft has a forward sweep wing configuration, and uses a conventional tail with two vertical stabilizers.

There exists several asymmetric aircraft designs but none of them have an asymmetric power plant installation seeking to exploit the BLI effect on any of their engines.

It would therefore be desirable to provide an aircraft design that provides a propulsive efficiency increase, without compromising the security and cost of conventional aircrafts.

### SUMMARY OF THE INVENTION

The present invention overcomes the above mentioned drawbacks by providing an aircraft configuration, which is asymmetric, and provides an aircraft propulsion efficiency increase without penalizing the cost of the same.

An object of the present invention is to provide an aircraft with a propulsive efficiency increase by ingesting the slow air in the fuselage boundary layer into the fan of an engine. The required thrust is produced with less power.

Another object of the invention is to maintain the cost-efficient reached on conventional aircraft although incorporating a new propulsion system.

The asymmetric aircraft configuration has a pair of wings—a first and a second, the first wing having a span larger than the second wing—a pair of engines —a first and a second—a rear end with a T-tail configuration, and a main landing gear assembly formed by a set of two landing gears.

The first engine of the aircraft is mounted on the larger wing of the aircraft, and the second engine is mounted on the rear end of the aircraft with its centerline aligned with the longitudinal axis of the aircraft. The second engine comprises a casing defining a forward inlet designed to ingest air forming a boundary layer over the fuselage of the aircraft, and an aft outlet to allow the exhaust of the engine. This second engine configured to ingest and consume air forming a boundary layer over the fuselage of the aircraft is thus configured as a boundary layer ingestion engine.

This aircraft configuration increases the propulsive efficiency of the aircraft by ingesting the slow air in the fuselage boundary layer into the fan of the second engine, so that the required thrust is produced with less power.

Also, having two engines maintains the costs of the aircraft, which for economic reasons it is desirable to build it with the smallest number of engines allowed by the regulations, which in the case of large commercial aircraft is two engines.

The aircraft has also an asymmetric main landing gear assembly, which is formed by a first landing gear, attached to the first wing, and a second landing gear attached to an area of the fuselage close to the second wing.

### BRIEF DESCRIPTION OF THE DRAWINGS

For a better comprehension of the invention, the following drawings are provided for illustrative and non-limiting purposes, wherein:

FIG. 1 shows a first state of the art aircraft configuration.

FIG. 2 shows a second state of the art aircraft configuration.

FIG. 3 shows a third state of the art aircraft configuration.

FIG. 4 shows a perspective view of the asymmetric aircraft configuration, according to a preferred embodiment of the invention.

FIG. 5 shows a front view of the aircraft shown in FIG. 4.

FIG. 6 shows a plant view of the aircraft shown in FIG. 4 and FIG. 5.

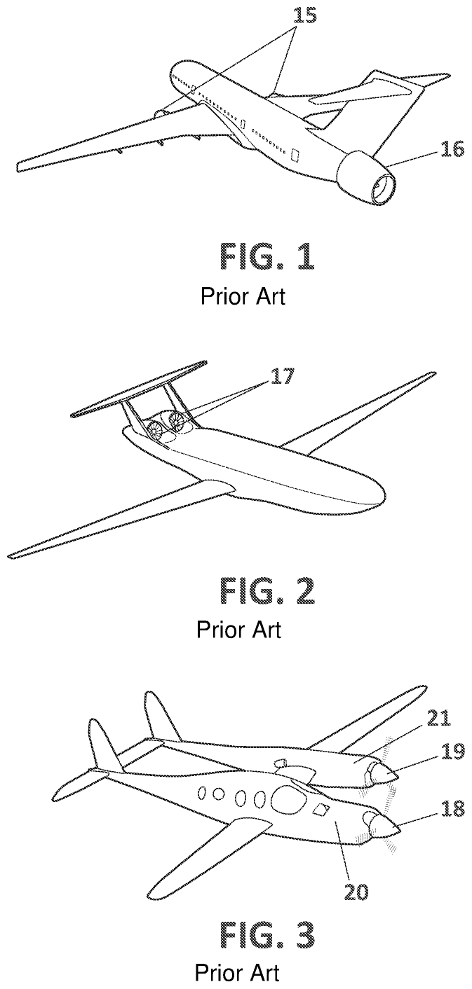

### DETAILED DESCRIPTION OF THE PREFERRED EMBODIMENTS

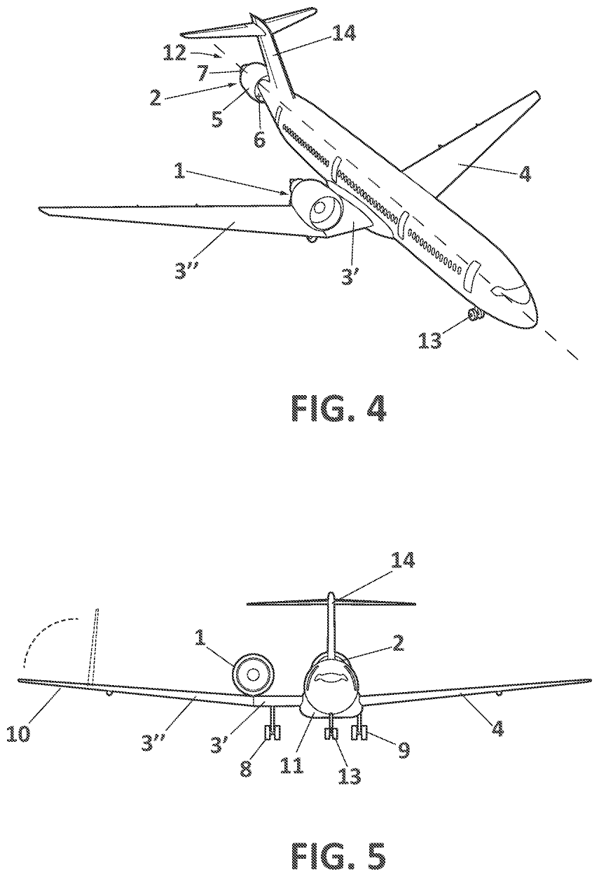

FIG. 4 shows an asymmetric aircraft configuration having a first (3′, 3″) and a second wing (4), the first wing (3′, 3″) having a span larger than the second wing (4). As shown, the first wing (3′, 3″) preferably comprises a root section (3′) attached to the fuselage, and a tip section (3″) extending outwardly from the root section (3′), the root section (3′) having a sweep angle different than the tip section (3″).

The aircraft has a T tail (14) configuration, and has two engines, a first engine (1) mounted on the first wing (3′, 3″) of the aircraft, and a second engine (2) mounted on the rear end of the aircraft. The first engine has to be installed on the first wing, since it has a larger span, in order to balance the aircraft laterally.

The second engine (2) has its centerline (12) aligned with the longitudinal axis of the aircraft, and has a casing (5) defining a forward inlet (6) designed to ingest a boundary layer during the flight, and an aft outlet (7) to allow the exhaust of the second engine (2).

The first engine (1) may be installed on the starboard wing to take advantage of the fact that this side of the aircraft is not accessed by passengers during boarding and disembarking operations.

As shown in FIG. 5, the aircraft has a main landing gear assembly comprising a first landing gear (8) attached to the first wing (3′, 3″), and a second landing gear (9) attached to an area of the fuselage close to the second wing (4).

According to a preferred embodiment, the first landing gear (8) is attached to the rear spar of the root section (3′) of the first wing (3′, 3″).

According to another preferred embodiment, the first wing (3′, 3″) is configured to receive the first landing gear (8) when retracted.

Alternatively, and according to another preferred embodiment, the fuselage is configured to receive the first landing gear (8) when retracted.

According to another preferred embodiment, the aircraft has a ventral fairing (11) configured to receive the second landing gear (9) when retracted.

As shown in FIG. 5, the tip section (3″) of the second wing has a foldable tip (10). This will enable extending the wing span to achieve desired performance characteristics without compromising the ability to park the aircraft in standard airport parking aprons.

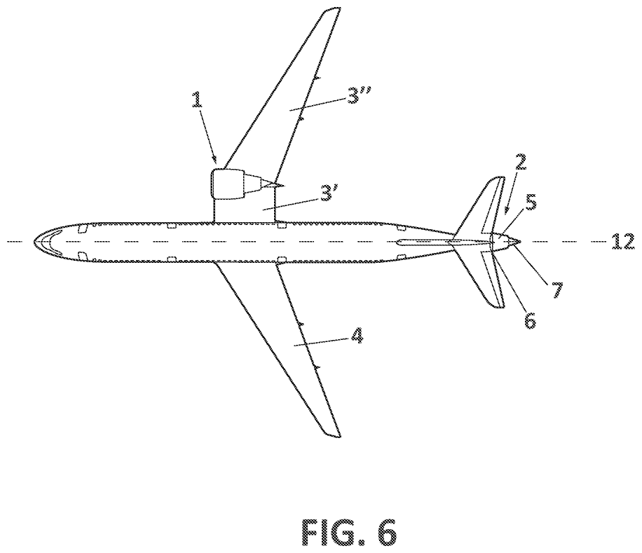

As shown in FIGS. 4-6, the first engine (1) is preferably mounted on the interface between the root (3′) and tip sections (3″).

According to another preferred embodiment, the tip section (3″) has the same size (chord and span) as the second wing (4).

Finally, according to another preferred embodiment, the first engine (1) is mounted over or under the first wing (3′, 3″) of the aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An asymmetric configuration for an aircraft comprising:
a first wing and a second wing, the first wing having a span larger than the second wing,
a first engine mounted on the first wing of the aircraft, and
a second engine mounted on a rear end of the aircraft with its centerline aligned with a longitudinal axis of the aircraft,
the rear end of the aircraft having a T tail, and
the second engine having a casing defining a forward inlet configured to ingest a boundary layer during a flight, and an aft outlet to discharge an exhaust of the second engine, and
a main landing gear assembly comprising a first landing gear attached to the first wing, and a second landing gear attached to an area of a fuselage close to the second wing.

2. The asymmetric aircraft configuration, according to claim 1, wherein the first wing comprises a root section attached to the fuselage, and a tip section extending outwardly from the root section, the root section having a sweep angle different than the tip section.

3. The asymmetric aircraft configuration, according to claim 2, wherein the first engine is mounted on an interface between the root section and the tip section.

4. The asymmetric aircraft configuration, according to claim 2, wherein the tip section has the same size as the second wing.

5. The asymmetric aircraft configuration, according to claim 2, wherein the tip section has a foldable tip.

6. The asymmetric aircraft configuration, according to claim 2, wherein the first landing gear is attached to a rear spar of the root section of the first wing.

7. The asymmetric aircraft configuration, according to claim 2, wherein the first wing is configured to receive the first landing gear when retracted.

8. The asymmetric aircraft configuration, according to claim 2, wherein the fuselage is configured to receive the first landing gear when retracted.

9. The asymmetric aircraft configuration, according to claim 2, wherein the aircraft has a ventral fairing configured to receive the second landing gear when retracted.

10. The asymmetric aircraft configuration, according to claim 1, wherein the first engine is mounted over or under the first wing of the aircraft.
